(19) United States
(12) Patent Application Publication
(10) Pub. No.: US 2020/0094534 A1
(43) Pub. Date: Mar. 26, 2020

(54) MULTI-LAYER SHRINK FILM

(71) Applicant: Intertape Polymer Corp., Sarasota, FL (US)

(72) Inventors: Clinton C. Staheli, Tremonton, UT (US); Trevor Arthurs, Truro (CA)

(73) Assignee: Intertape Polymer Corp., Sarasota, FL (US)

(21) Appl. No.: 16/579,539

(22) Filed: Sep. 23, 2019

Related U.S. Application Data
(60) Provisional application No. 62/735,336, filed on Sep. 24, 2018.

(51) Int. Cl. B32B 27/08; B32B 7/05; B32B 7/02; B32B 37/00

(52) U.S. Cl. CPC B32B 27/08; B32B 37/0084; B32B 7/02; B32B 7/05

(57) ABSTRACT

A multilayer shrink film composite is disclosed and described the shrink film comprising a first shrink film, at least one other shrink film, the at least one other shrink film being adjacent the shrink film, and a plurality of spaced apart welds between the shrink film and the at least one other shrink film. Methods of producing the multilayer shrink film are also provided.

### CROSS-REFERENCE TO RELATED APPLICATIONS

This application claims priority to U.S. Provisional Application Ser. No. 62/735,336, entitled “MULTI-LAYER-SHRINK FILM”, filed Sep. 24, 2018, which is incorporated herein by reference in its entirety.

### TECHNICAL FIELD

In general, the present disclosure relates to shrink films, and particularly to composite shrink films including two or more individual shrink film that are layered together, and at least partially joined together to effectively provide a unitary film.

### BACKGROUND

Shrink films are typically polymeric films that are applied over or around a substrate. When heated, shrink wrap films are capable of contracting or shrinking by about 20% to about 85%, or more of their original surface area.

### SUMMARY

A shrink film composite is provided, the shrink film composite comprising a first shrink film, at least one other shrink film, the at least one other shrink film being adjacent the shrink film; and, a plurality of spaced apart welds between the shrink film and the at least one other shrink film. In one aspect, the first shrink film and the at least one other shrink film are in a surface-to-surface configuration.

In another aspect, alone or in combination with any of the previous aspects, the first shrink film and the at least one other shrink film are of the same material or of the same thickness. In another aspect, alone or in combination with any of the previous aspects, the first shrink film and the at least one other shrink film are of a different material or of a different thickness.

In another aspect, alone or in combination with any of the previous aspects, the first shrink film and the at least one other shrink film possess different physical parameters selected from surface roughness, coefficient of friction, tear resistance, puncture resistance, and moisture vapor barrier resistance. In another aspect, alone or in combination with any of the previous aspects, the first shrink film and the at least one other shrink film are oriented in a machine or a transverse direction. In another aspect, alone or in combination with any of the previous aspects, the first shrink film or the at least one other shrink film is oriented in a machine or a transverse direction. In another aspect, alone or in combination with any of the previous aspects, the shrink film composite is oriented in a machine or a transverse direction.

A method of producing a shrink film composite is provided, the method comprising arranging a first shrink film with at least one other shrink film in a surface-to-surface configuration; and providing a plurality of spaced-apart bond points between the first shrink film and the at least one other shrink film; and forming a shrink film composite.

In one aspect, the plurality of spaced apart bond points are ultrasonic welds. In another aspect, alone or in combination with any of the previous aspects, the plurality of spaced apart bond points are laser welds.

In another aspect, alone or in combination with any of the previous aspects, the shrink film composite is substantially absent adhesive welds. In another aspect, alone or in combination with any of the previous aspects, the shrink film composite is absent adhesive welds.

In another aspect, alone or in combination with any of the previous aspects, the first shrink film and the at least one other second shrink film are oriented in a machine direction and or a transverse direction. In another aspect, alone or in combination with any of the previous aspects, the first shrink film or the at least one other shrink film is oriented in a machine and/or a transverse direction.

In another aspect, alone or in combination with any of the previous aspects, the method further comprises orienting the shrink film composite in a machine and/or a transverse direction.

### BRIEF DESCRIPTION OF DRAWINGS

FIG. 1 shows an exploded view of a multilayer shrink film as disclosed and described herein.

FIG. 2A shows a partial section view along line 2A-2A of the multilayer shrink film of FIG. 1.

FIG. 2B shows a partial section view along line 2A-2A of the multilayer shrink film of FIG. 1 with an optional additional shrink film.

FIG. 3 depicts an exemplary manufacturing process for producing the multilayer shrink film as disclosed and described herein.

### DETAILED DESCRIPTION

The phrase “unitary film” as used herein refers to a layered film comprising two or more films of the same or different material that are sufficiently joined, such as by thermal/ultrasonic bonding means, to be handled, processed, or otherwise utilized, as a unitary film or web.

The terms “laminate” and “composite”, when used to describe films of the present disclosure, are used interchangeably and are synonymous. Both refer to a film or web structure comprising at least two films joined in a face to face relationship to form a multiple-layer unitary film.

The term “polymer” is inclusive of homopolymers and copolymers, including, for example, block, graft, random and alternating copolymers, terpolymers, etc., and blends and modifications thereof. Furthermore, unless otherwise specifically limited, the term “polymer” is meant to include all possible stereochemical configurations of the material, including isotactic, syndiotactic and random configurations, such as those prepared using Ziegler-Natta or metallocene catalysts.

The term “substantially” means that a given property or parameter can vary by about 10% from the stated value.

The present disclosure provides a three dimensional film laminate containing at least one shrink film layer and at least one other layer bonded to the shrink film layer. In one example, the at least one other layer bonded is a shrink film layer of the same or of a different material. In another example, a composite shrink film is provided where the individual films are layered together, and the individual layers are at least partially joined to one another such that the final resultant composite film can be handled as a unitary film (e.g., maintained on a single roll/dispenser, applied to an article(s) to be wrapped in a single operation/as a single film, and shrunk in a single operation). In one example, the composite shrink film provides surface-to-surface contact between the individual films of the multilayer composite and is bonded in a plurality of spaced apart bonding locations. Further, by being at least partially joined to one another via a plurality of spaced apart bonding locations, the individual layers resist separation/or translation relative to each. It will be appreciated that the composite shrink film of the present disclosure can include any number of individual shrink film layers that can be suitably joined together. Accordingly, the present disclosure should not be construed as being limited to a composite shrink film only including two individual shrink film layers.

Shrink films consistent with the present disclosure include non-oriented polymeric films and/or oriented polymeric films. By way of example, the present disclosure includes a multilayer heat shrink film composite comprising oriented polymeric films that, upon application of suitable heat, preferentially linearly shrink along one or more direction (e.g., along the machine direction and/or the transverse direction of the film). In another example, the present disclosure includes a multilayer heat shrink film composite comprising non-oriented polymeric films that, upon application of suitable heat, shrink essentially uniformly along the machine direction and the transverse direction.

In some such examples, upon application of suitable heat, one or more of the individual films of the composite shrink film is configured to shrink relatively tightly around an article or object covered by, or in closer proximity to, one of the layers of the shrink film. When the individual shrink film layers (which can exhibit the substantially identical or substantially different shrink characteristics) are joined to one another to form the composite shrink film, the composite shrink film exhibits the above-noted shrink characteristics.

Consistent with the present disclosure, the individual shrink film layers can include any suitable shrink film, such as, but not limited to polyethylene (e.g., high-density polyethylene, low density polyethylene, linear low-density polyethylene, etc.), polypropylene, other polyolefin materials, polyvinylchloride, polyesters, nylons and other various barrier films, etc. In some example examples, the individual film layers of the composite can have a thickness of between about 0.3-3.0 mil. In some examples, the individual film layers of the composite can have a thickness of between about 0.3-1.5 mil. It will be appreciated that individual film layers of other varying thicknesses can also be used consistent with the present disclosure. The composite film can include two or more individual film layers, providing a composite film thickness generally corresponding to the number of individual film layers and the thickness of the individual film layers. In various examples, the individual film layers can have a similar thickness as one another, and/or can have a different thickness from one another. Spot weld size, collectively or independently, can range from 0.5 mm diameter circles up to continuous lines or stripes. The spacing between welds can be configured to correspond to a desired total welded area.

As discussed above, the individual film layers are joined to one another to effectively form a unitary film. For example, the individual film layers of the composite film can remain joined together during use, e.g., allowing the composite film to be applied to an article/object as a unitary film (e.g., in a single operation and/or using a single apparatus), and can be shrunk as a unitary film (e.g., in a single operation and/or using -a the same heating apparatus). In some implementations, the individual film layers can be joined to provide a composite shrink film that is thicker (e.g., having a heavier gauge) than can conveniently be provided by a single layer film. For example, conventional equipment and processes for forming shrink film can have an upper film thickness that can readily/economically be achieved.

In another example, the composite shrink film can be cross-linked (e.g., to increase the film strength and heat integrity) using electron beam irradiation.

Conventional/economically reasonable irradiation of the composite shrink film can have an upper film thickness that can be suitably penetrated for crosslinking, thereby providing a maximum film thickness that can be achieved via conventional and/or economical processes. Consistent with some examples of the present disclosure, two or more individual shrink film layers can be formed using conventional and/or economical processes, and joined together to provide a composite shrink film of a greater thickness (e.g., and other generally corresponding properties, such as tear strength, barrier, puncture resistance, etc.) as compared to the individual film layers. In one example, the multilayer shrink film of the present disclosure excludes non-shrink films.

In some examples consistent with the present disclosure, two or more individual shrink film layers are joined together to provide a composite shrink film that exhibits a combination of properties that cannot readily be available in conventional/economical individual layer shrink films (e.g., which can be formed from conventional shrink film materials and/or using conventional shrink film processes). For example, two or more individual shrink film layers having different characteristics (e.g., physical, mechanical, and/or chemical) from one another can be joined to provide a composite shrink film that exhibit a combination of properties that cannot readily and/or economically be achievable in a single layer shrink film.

For example, the two or more individual shrink film layers can provide cosmetic features, such as a colored outer shrink film layer and an opaque inner shrink film layer. For example, the outer shrink film layer can have a white color, while the inner shrink film layer can have a gray color. It will be appreciated that various other color combinations can be utilized. It will also be appreciated that the various individual shrink film layers can include different graphic patterns, or the like. It will be appreciated that one or both of the opposing surfaces of the multilayer shrink film composite can have a similar or dissimilar surface texture, coefficient of friction and/or functional property for example, the surface, intended to be adjacent to an article to be shrunk wrapped, can possess a surface roughness, coefficient of friction, and/or functional property greater than or less than that of the opposing surface, irrespective of any intermediate shrink films between the opposing surfaces of the composite.

For example, one of the at least two individual shrink film layers (or one or more films of a multi-layered composite shrink film) can include a material providing a relatively high abrasive resistance (for example on a shrink film layer intended to be positioned as the outer layer), and another of the individual shrink film layers can include a material that can provide a relatively high puncture resistance (for example on a shrink film layer intended to be positioned as an inner layer). As such, the outer layer of an exemplary composite shrink film can provide relatively high abrasion resistance on a surface that can be expected to experience a greater degree of abrasion, while the corresponding inner layer can provide a relatively high puncture resistance for the composite shrink film. According to another example embodiment, at least two individual shrink film layers can be configured to provide a relatively high differential coefficient of friction relative to one another or a surface. It will be appreciated that various other combinations of aesthetic, mechanical, or other properties can be provided by the two or more individual shrink film layers, such as abrasion/puncture/barrier/color contrast/coefficient of friction, for example.

In a particular implementation, a composite shrink film herein disclosed can be utilized in an overwrap application. For example, a composite shrink film can be utilized to provide an outer wrapping for shipping of articles, including shipping merchandise to consumers via postal/parcel services. In some such examples, the overwrap can provide physical and/or tamper protection for the articles being shipped. In such an application, the articles being shipped can be subject to relatively rough handling and/or adverse environmental conditions. In such an application, a relatively thick and tough overwrap shrink film (e.g., as can be provided by a composite shrink film disclosed herein) can provide an increased durability that can aid in withstanding the conditions experienced during shipping. It will be appreciated that composite shrink films consistent with the present disclosure can be utilized in a myriad of applications in addition/as an alternative to overwrap application.

As discussed above, the two or more individual shrink film layers can be joined together to form a single composite shrink film. In various examples, the individual shrink film layers can be joined together by way of intermittent welding of the individual shrink film layers. Example welding processes for intermittently welding the individual shrink film layers can include, but are not limited to, ultrasonic welding and laser welding. In one example, the one or more individual shrink film layers are joined together in a surface-to-surface configuration substantially without adhesive or melt adhesive. In one example, the one or more individual shrink film layers are joined together in a surface-to-surface configuration without any adhesive or melt adhesive.

In some examples, the welding is sufficiently localized to prevent and/or minimize distortion of the individual shrink film layers outside of the welding zones (e.g., due to heating or otherwise mobilizing the polymer chains of the films to allow shrinking of the films). Accordingly, in such examples, the cosmetic appearance and/or shrinkage performance of the composite shrink film would not be substantially deteriorated or compromised by the welding process.

Continuing with the foregoing, in some examples, the individual shrink film layers can be spot welded together using appropriate plastic welding techniques to join the individual shrink film layers. The spacing and/or placement of the spot welds throughout the composite shrink film can be selected to resist separation of the individual shrink film layers from one another. Additionally and/or alternatively, the spacing and/or placement of the spot welds throughout the composite shrink film can facilitate handling and/or management of the composite shrink film as a unitary film. For example, the spacing and/or placement of the spot welds can reduce and/or eliminate the bunching, wrinkling, and/or movement of an individual shrink film layer relative to another individual shrink film layer (e.g., in regions in between spot welds of two films of different chemical composition). As such, the spacing and/or placement of the spot welds can facility applying the composite shrink film to an article (e.g., via wrapping the article using one surface as opposed to another, heat or adhesive sealing the composite shrink film to itself around the article, etc.), cutting the composite shrink film to a desired size and/or shape (while maintaining the individual shrink film layers joined together), providing for tearing and removing of the composite shrink film from the article, and/or otherwise handling and managing the composite shrink film.

In some examples, the intermittent welding of the individual shrink film layers provide features in addition to merely joining the individual shrink film layers. For example, in one example the intermittent welding can provide a cosmetic or aesthetic appearance to the composite shrink film (e.g., in the pre-shrink and/or post shrink configuration and/or provide for differentiation of a pre-shrink and/or post shrink configuration). For example, the intermittent welding can be at least partially provided in a decorative pattern, a company logo, textually presented information/instructions, watermarks, or the like. In various examples, the cosmetic appearance can be provided by one or more continuously welded patterns, intermittently welded patterns, random patterns, dot matrix representations, or the like. Consistent with such examples, the cosmetic appearance can be visually perceptible in one or more of the pre-shrink and/or post shrink configuration of the composite shrink film. Further, it will be appreciated that the intermittent welding of the individual shrink film layers can include both cosmetic aspects (e.g., including a pattern, design, text, etc.) and non-cosmetic aspects (e.g., intermittent welds provided substantially for joining the individual shrink film layers).

In some implementations, the intermittent welding of the composite shrink film can provide structural characteristics in addition to merely joining the individual shrink film layers. For example, in some examples a plurality of spot welds can provide a rip-stop function in one or more directions along the composite shrink film (e.g., in a machine direction of the film, in a transvers direction of the film, and/or in any other direction). In another example, the spot welds can include rows and/or columns of intermittent linear weld lines. The intermittent weld lines can be offset such that a tear propagating through the film can intersect a weld line, which can exhibit a higher tear strength than adjacent, non-welded, portions of the composite film. Due to the offset nature of the weld lines, even if the tear passes between adjacent weld lines of one or more rows and/or columns of intermittent linear weld lines, the tear can eventually intersect a weld line, which can function as a rip-stop feature.

In various examples, the plurality of intermittent spot welds can include any suitable shape, arrangement, and/or configuration. For example, the plurality of intermittent spot welds can include, but are not limited to, weld points (e.g., weld “dots”), open and/or closed geometric shapes (e.g., circles, squares, octagons, etc.), linear segments (e.g., arranged in rows, columns, random patterns, cosmetic patterns, etc.), parallel linear segments, alternating orthogonal and/or angled linear segments, as well as various other configurations. It will be appreciated that in addition/as an alternative to intermittent linear weld lines, various other spot welding configurations can be utilized. In one example, the composite shrink film is heat sealed along opposing lateral edges in the machine direction and contains a plurality of spot welds or weld points there between, with the proviso that the positioning of the plurality of spot welds or weld points substantially prevent any air-gap between individual shrink films before or after heat shrinking.

In one example, less than 50% of the total surface area of the pre-shrunk composite shrink film is attributable to the total surface area of the plurality of spot welds. In another example, less than 40% of the total surface area of the pre-shrunk composite shrink film is attributable to the total surface area of the plurality of spot welds. In another example, less than 30% of the total surface area of the pre-shrunk composite shrink film is attributable to the total surface area of the plurality of spot welds. In another example, less than 20% of the total surface area of the pre-shrunk composite shrink film is attributable to the total surface area of the plurality of spot welds. In another example, less than 10% of the total surface area of the pre-shrunk composite shrink film is attributable to the total surface area of the plurality of spot welds. In another example, less than 1% of the total surface area of the pre-shrunk composite shrink film is attributable to the total surface area of the plurality of spot welds.

According to one illustrative example, the two or more individual shrink film layers can be point welded (e.g., welded via a plurality of generally evenly spaced weld points that can have a relatively small weld area) to one another. In such an embodiment, the size and density (e.g., number of welds per square surface area) can be selected to provide a desired lamination strength, while maintaining a desired shrinkage performance for the resultant composite shrink film. According to another illustrative embodiment, the two or more individual shrink film layers can be welded together by way of short oval or rectangular shaped welds. In a particular illustrative embodiment, the short oval or rectangular welds can be oriented at an angle to the machine direction of at least one of the individual shrink film layers (e.g., the long axis of the oval or rectangular welds can be oriented at an angle relative to the machine direction of at least, if not both, of the individual shrink film layers). Consistent with such a configuration, desired shrinkage performance of the resultant composite shrink film can be achieved while providing at least a degree of rip stop character to the resultant composite shrink film. It will be appreciated that other configurations can also be utilized, e.g., for achieving various desired characteristics and/or combinations of characteristics in the final composite shrink film.

Consistent with the foregoing, a composite shrink film can generally include two or more than two, individual shrink film layers. The two or more individual shrink film layers can be joined together to form the composite shrink film. The two or more individual shrink film layers can be joined together via a plurality of welds between the two or more individual shrink film layers. The plurality of welds can be formed by any suitable welding operation, including, but not limited to, ultrasonic welding and laser welding. The plurality of welds can include one or more of point welds, welds having a geometric configuration, and welds have a non-geometric configuration. At least a portion of the plurality of welds can provide a cosmetic appearance. The cosmetic appearance can include one or more of a design, a logo, and textual information.

At least a portion of the plurality of welds can provide a reinforcing effect. The reinforcing effect can include a rip-stop effect along one or more direction of the composite shrink film. At least a portion of the plurality of welds can be arranged in a row and/or column arrangement. At least a portion of the plurality of welds can include linear segments. At least a portion of the plurality of welds can be arranged generally parallel to one another. At least a portion of the plurality of welds can be arranged at an angle to at least another portion of the plurality of welds. At least a portion of the plurality of welds can be arranged orthogonally to at least another portion of the plurality of welds. At least a portion of the plurality of welds can include linear segments generally oriented in a machine direction of at least one of the individual shrink film layers. At least a portion of the plurality of welds can include linear segments generally oriented in a transverse direction of at least one of the individual shrink film layers. At least a portion of the plurality of welds can include linear segments generally oriented at an angle relative to one or more of the machine direction and/or the transverse direction of at least one of the individual shrink film layers.

In one example, the composite shrink film comprises at least three layers, e.g., one shrink film layer sandwiched between two different shrink film layers or a repeating pattern of one shrink film layer sandwiched between two different shrink film layers. Additional multilayer constructions, containing more than three layers, can be configured and are advantageous. In one example, the multilayer composite shrink film is configured such that pleating or warping of the surface of the composite upon heat shrinking is eliminated or reduced. Thus, for example, the individual film layers of the multilayer composite film can be configured to have substantially similar heat shrinking profiles along the transverse and/or machine directions, whether or not the individual film layers are of the same material, different material, and/or different thicknesses, so as to avoid pleating or warping of the surface of the composite during or after heat shrinking.

In another aspect, the present subject matter provides a method of adhering a heat shrinkable film to a substrate. The method comprises applying a shrink film composite to an article substrate; and shrinking the shrink film so the shrink film conforms to the contours of the article.

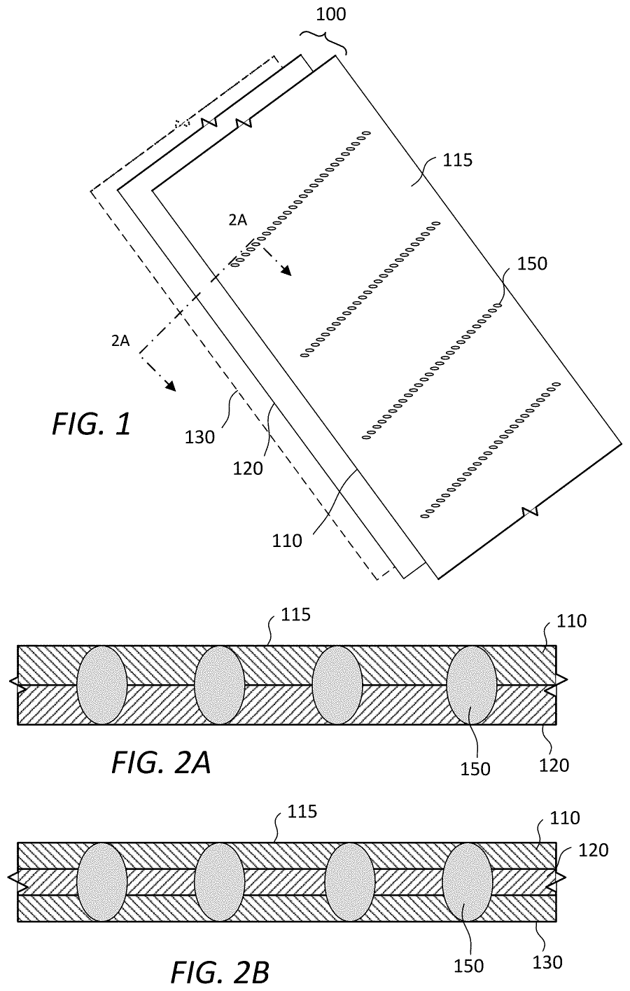

An exemplary composite shrink film 100 in accordance with the disclosure is illustrated schematically as an exploded view in FIG. 1 where the a first shrink film 110 is positioned in surface-to-surface contact with a second shrink film 120, optionally with additional shrink film 130, to provide a pre-bonded laminate suitable for shrink wrapping. First film 110 and second film 120 and/or additional shrink film 130, can be of the same material, of different materials, and/or of the same thickness.

It is understood that first film 110 and/or second film 120, independently can be been oriented in the machine and/or transverse direction by any manner known in the art. It should be understood that pre-bonded laminate of multilayer shrink film 100 can be oriented in the machine and/or transverse direction by any manner known in the art. For example, the individual films 110, 120, additional shrink film 130 or the pre-bonded laminate can be by fed through a series of heated rollers to uniformly heat the film(s) 110 and/or 120 and/or additional shrink film 130 to a suitable stretching temperature, e.g., between the glass-transition temperature T g and the melting point Tm of the respective polymer forming the film(s), or between the softening temperature and the melting point Tm of the polymer forming the film(s). For example, when an ethylene polymer or propylene polymer film layer is utilized, a stretching temperature of between about 60° C. and about 100° C. can be used. The individual film 110 or 120 or the juxtaposed pre-bonded laminate can then be fed into a set of stack rollers with variable rotational speed control so as to apply a stretching tension to stretch and orient the polymer molecules of the film(s). The pre-bonded film laminate 10 can be stretched to any desired level, for example, to a final length in the range between about 200% and 600% of the original length.

FIG. 2A illustrates an exemplary bi-laminate composite shrink film 100 in accordance with the present disclosure, comprising a first shrink film 110 having major surface 115. A second shrink film 120, which may be the same or different thickness and/or material is positioned adjacent to surface 115 of the first shrink film 110, such as by a plurality of spaced apart welds 150.

FIG. 2B illustrates an exemplary tri-laminate composite shrink film 100 in accordance with the present disclosure, comprising a first shrink film 110 having major surface 115. A second shrink film 120, which may be the same or different thickness and/or material is positioned adjacent to surface 115 of the first shrink film 110, and a third shrink film 130 is sandwiched between the second shrink film and the first shrink film, the plurality of films of the laminate are bonded together, such as by a plurality of spaced apart welds 150. Other multi-laminate configurations are envisioned.

In one example, a composite production process is not limited to the above-described machine direction (MD) stretching and MD relaxing process. The composite can be stretched and then laminate can be relaxed in cross-machine direction (CD) using, for example, a tenter frame. Additionally, the laminate production process can be modified to apply biaxial, i.e., both CD and MD, stretching and relaxing steps to provide a highly and multidirectional texturized laminate. The film layer can be separately stretched and subsequently used to form the laminate, or the laminate can be made in a continuous process. Alternatively, commercially available uniaxial or biaxial oriented films can be utilized.

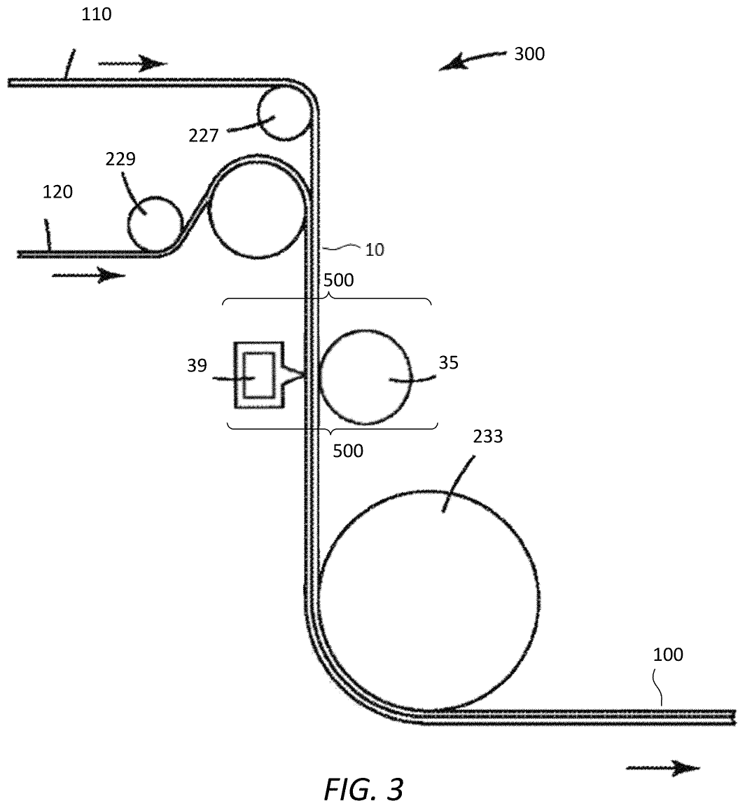

Presented in FIG. 3 is an exemplary manufacturing process 300 where first shrink film 110 is unwound and run through a single pass on a primary process line 227. Optionally, first shrink film 110 can be pretreated, such as corona, flame or UV oxidizing a top surface of the first shrink film 110.

Second shrink film 120, is unwound and run on an auxiliary line 227 which brings the first and second shrink films 110, 120 into surface-to-surface relationship for presentation to a sonic welding device 500 via roll 229. In the sonic welding device 500, horn 39 and anvil roller 35 provide sonic pressure to the first and second shrink films 110, 120 for providing the multilayer shrink film composite 100. Bonding can provide in any pattern as provided on the anvil roller 35. In one example, welding can be performed on a continuously-fed web at line speeds ranging from about 1 m/min to about 300 m/min. Other line speeds can be employed.

Ultrasonic welding through the use of a stationary horn 39 and a patterned anvil roll 233 can be employed as is known in the art, such as U.S. Pat. No. 5,817,199, however, any other ultrasonic welding technique can be used in the present disclosure.

While various features and examples have been described herein, it will be appreciated that the principles described are susceptible to modification and variation. As such, the foregoing description should not be construed as limiting on the scope of the present disclosure.

1. A shrink film composite comprising
a first shrink film;
at least one other shrink film, the at least one other shrink film being adjacent the shrink film; and,
a plurality of spaced apart welds between the shrink film and the at least one other shrink film.

2. The shrink film composite of claim 1, wherein first shrink film and the at least one other shrink film are in a surface-to-surface configuration.

3. The shrink film composite of claim 1, wherein first shrink film and the at least one other shrink film are of a same material or of a same thickness.

4. The shrink film composite of claim 1, wherein first shrink film and the at least one other shrink film are of a different material or of a different thickness.

5. The shrink film composite of claim 1, wherein first shrink film and the at least one other shrink film possess different physical parameters selected from surface roughness, coefficient of friction, tear resistance, puncture resistance, and moisture vapor barrier resistance.

6. The shrink film composite of claim 1, wherein, independently, the first shrink film or the at least one other shrink film is oriented in a machine or a transverse direction.

7. The shrink film composite of claim 1, wherein shrink film composite is oriented in a machine and/or a transverse direction.

8. The shrink film composite of claim 1, wherein first shrink film and the at least one other shrink film are absent adhesive welds.

9. A method of producing a shrink film composite, the method comprising
arranging a first shrink film with at least one other shrink film in a surface-to-surface configuration; and
providing a plurality of spaced-apart bond points between the first shrink film and the at least one other shrink film; and
forming a shrink film composite.

10. The method of claim 9, wherein the plurality of spaced apart bond points are ultrasonic welds.

11. The method of claim 9, wherein the plurality of spaced apart bond points are laser welds.

12. The method of claim 9, wherein the shrink film composite is substantially absent adhesive welds.

13. The method of claim 9, wherein the shrink film composite is absent adhesive welds.

14. The method of claim 9, wherein the first shrink film and the at least one other shrink film are oriented in a machine direction and or a transverse direction.

15. The method of claim 9, wherein the first shrink film or the at least one other shrink film is oriented in a machine and/or a transverse direction.

16. The method of claim 9, further comprising orienting the shrink film composite in a machine and/or a transverse direction.
